(19) United States
(12) Patent Application Publication
(10) Pub. No.: US 2026/0044015 A1
(43) Pub. Date: Feb. 12, 2026

(54) GLASSES WITH BISTABLE HINGE

(71) Applicant: LUXOTTICA S.R.L., Agordo (BL) (IT)

(72) Inventor: Moreno DAL PONT, Belluno (BL) (IT)

(21) Appl. No.: 19/099,337

(22) PCT Filed: Jul. 25, 2023
(86) PCT No.: PCT/IB2023/057536

§ 371 Date: Jan. 28, 2025

(30) Foreign Application Priority Data
Jul. 29, 2022 (IT) 102022000016173

(51) Int. Cl. G02C 5/22

(52) U.S. Cl. CPC G02C 5/2218

(57) ABSTRACT

Glasses (200) comprising a front (210) and two temples (220) rotatably coupled to the front (210) so as to rotate between a first stable opening position and a second stable closing position, the front (210) comprises two first receiving seats (211), two hinge assemblies (100) each of which comprises a hinging body (110) coupled to a respective temple (210) so that it has an end portion (111) which protrudes overhanging with respect to the temple (220) and penetrates a respective one of such first receiving seats (211) in which it is rotatably coupled to the front (210), an elastic element (130) in abutment with a bottom wall of the respective first receiving seat (211) and the end portion (111), the elastic element (130) is preloaded in compression with a preloading force, the hinging body (110) and the elastic element (130) are configured in such a way that when the respective temple (220) is in the first stable opening position or in the second stable closing position, the elastic element (130) exerts a first thrust force that is equal and opposite to the preloading force on the end portion (111), and when the respective temple (220) passes from the first stable opening position to the second stable closing position, or vice versa, said elastic element (130) is compressed with a compressive force greater than said preloading force exerted by said end portion (111).

The present invention refers to glasses with bistable hinge.

As known, glasses provided with bistable hinges are available nowadays. Such hinges allow to keep an opening position in which the temples of the glasses are open, and a closing position in which such temples are closed.

Usually, the bistability of the hinge is given by the interaction of different joint elements located in the hinging area between the temples and the front working in a free condition between a first opening position and a second closing position. Said free condition returns a feeling of low perceived quality of the object to the user.

Furthermore, the commonly known bistable hinges provide a bulk such as to have an impact on the aesthetics itself of the temple and generally of the glasses.

The object of the present invention is to overcome the above-mentioned drawbacks and in particular to devise glasses comprising a hinge assembly which works without clearance and with a high-value perceived quality.

Furthermore, a further object of the present invention is to make glasses comprising a hinge assembly being aesthetically pleasant and minimizing the bulk of the hinge actuating mechanism on the temple, as well as being easy to assemble and ensuring a quick and simple maintenance.

This and other objects according to the present invention are achieved making glasses as set forth in claim 1.

Further features of the glasses are object of the dependent claims.

The features and advantages of the glasses according to the present invention will be more apparent from the following exemplary and non-limiting description, referred to the attached schematic drawings in which:

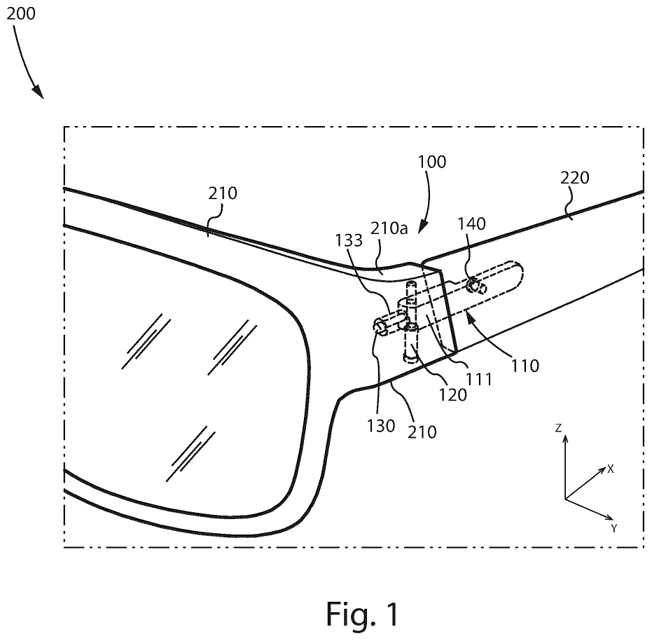

FIG. 1 is a perspective view of the glasses according to the present invention with the temples of the glasses in a first stable opening position;

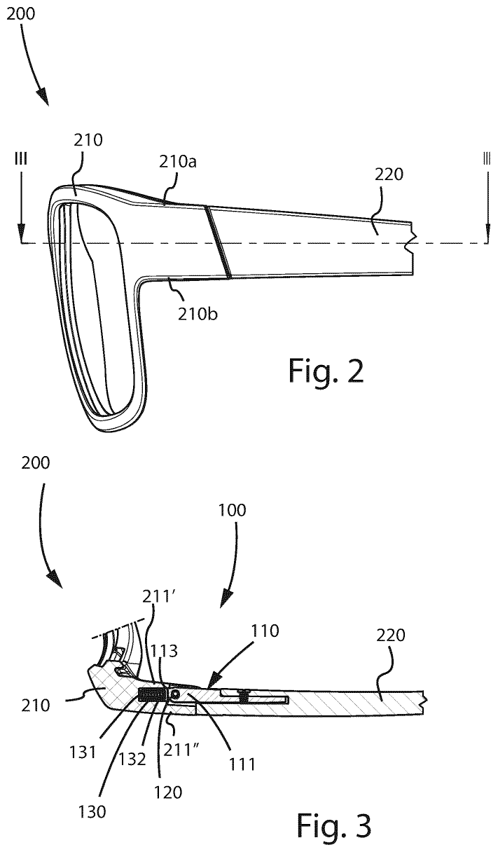

FIG. 2 is a first side view of the glasses of FIG. 1;

FIG. 3 is a first sectional view along the line III-III of the glasses of FIG. 2;

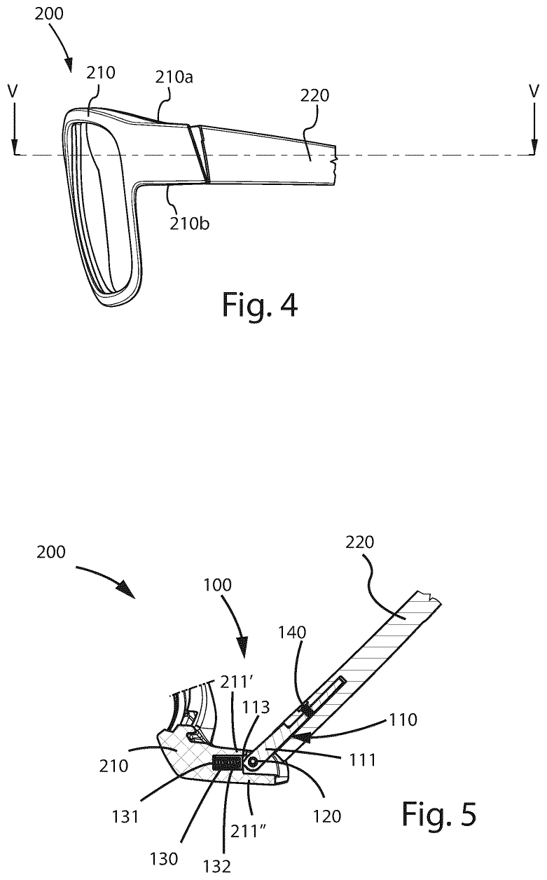

FIG. 4 is a second side view of the glasses according to the present invention when the temples of the glasses are in an intermediate position between the first stable opening position and a second stable closing position;

FIG. 5 is a second sectional view along the line IV-IV of the glasses of FIG. 4;

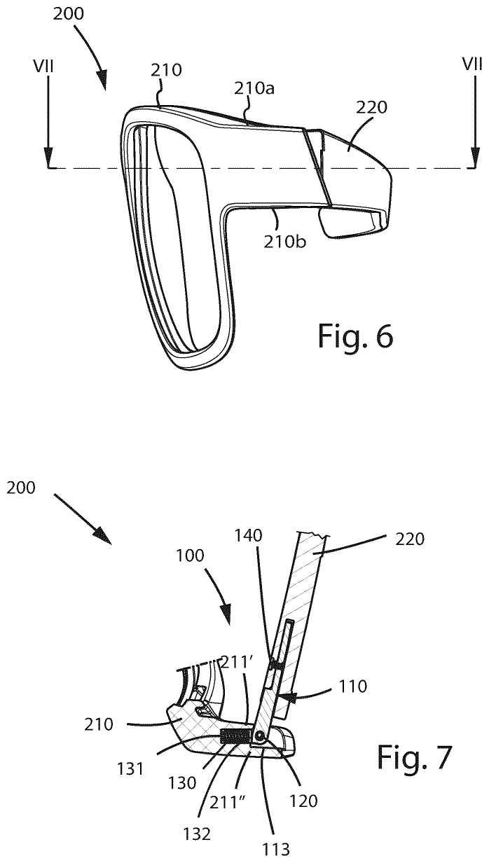

FIG. 6 is a third side view of the glasses according to the present invention when the temples of the glasses are in the second stable closing position;

FIG. 7 is a third sectional view along the line VI-VI of the glasses of FIG. 6;

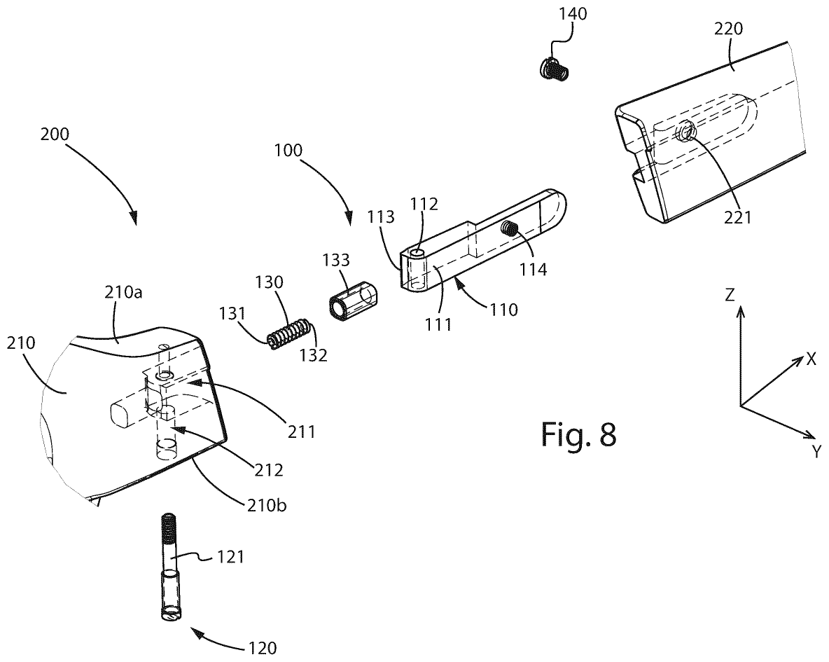

FIG. 8 is an exploded perspective view of the glasses according to the present invention;

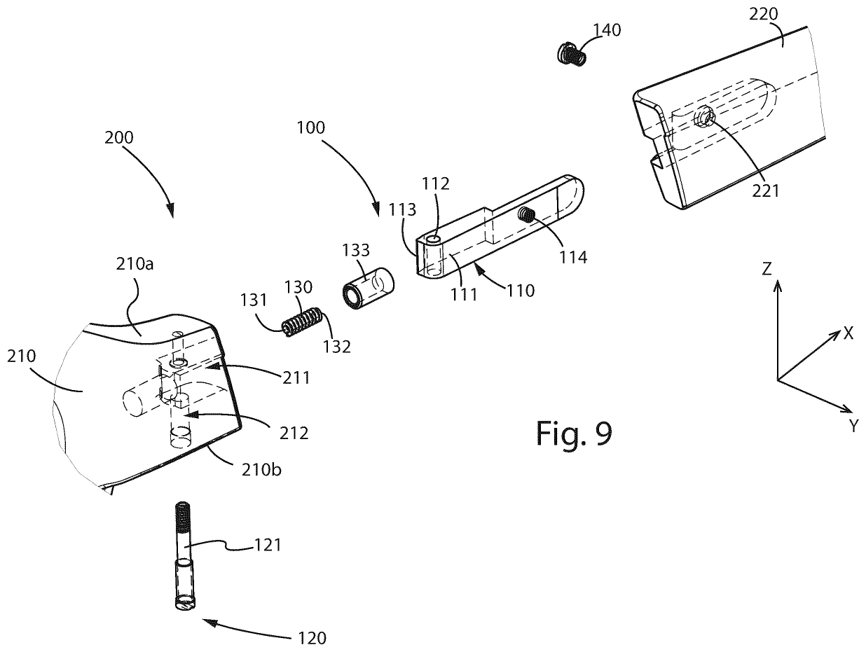

FIG. 9 is an exploded perspective view of the glasses according to an alternative embodiment of the present invention.

With reference to the figures, glasses overall denoted by 200 are shown.

In the present description, reference to a Cartesian axis system XYZ represented in figures comprising a longitudinal axis X, a transverse axis Y and a vertical axis Z and to an orientation of the glasses 200 as that illustrated in FIG. 8 will be made for the sake of simplicity and clarity of exposition.

Such glasses 200 comprise a frame comprising in turn a front 210 adapted to support two lenses and two temples 220 adapted to allow a user to wear the glasses 200.

The temples 220 are rotatably coupled to the front 210 so as to rotate between a first stable opening position in which the temples 220 are open and the glasses 200 can be worn, and a second stable closing position in which the temples 220 are closed and the glasses 200 cannot be worn.

Advantageously, the front 210 comprises two first open receiving seats 211 facing the temples 220.

Each first receiving seat 211 is a recess obtained at the coupling zone between the front 210 and the respective temple 220. Advantageously, the glasses 200 comprise two hinge assemblies overall denoted by 100, by means of which the temples 220 are rotatably coupled to the front 210.

Each hinge assembly 100 comprises a hinging body 110 coupled to a respective temple 220 so that it has an end portion 111 which protrudes overhanging with respect to the temple 220 and penetrates at least a portion of a respective one of such first receiving seats 211 in which it is rotatably coupled to said front 210.

In a particular embodiment, as that illustrated in figures, the front 210 also comprises two second receiving seats 212 in communication with the first receiving seats 211 and having an axis that is transverse with respect to that of the first receiving seats 211. Preferably, the axes of the first receiving seats 211 and the second receiving seats 212 are substantially mutually perpendicular. Even more preferably, the axis of the first receiving seats 211 is substantially parallel to the longitudinal axis X and the axis of the second receiving seats 212 substantially parallel to the vertical axis Z.

In more detail, the second receiving seats 211 are recesses obtained from a first surface 210a of the front 210 or a second surface 210b of the front 210 opposite to the first surface 210a.

In the case where the front 210 comprises the second receiving seats 212, the end portion 111 can be provided with a first through hole 112 arranged at a respective second receiving seat 212 and coaxial thereto. Preferably, the axes of the first through hole 112 and of the respective first receiving seat 211 are substantially mutually perpendicular.

Furthermore, the hinge assembly 100 can also comprise a first coupling pin 120 which is housed in a respective second receiving seat 212 and which passes through the first through hole 112 so as to achieve a rotatable coupling with the end portion 111 of the hinging body 110.

Therefore, the hinging body 110 can rotate around the axis passing through the first through hole 112 and the respective second receiving seat 212, thus forming the above-mentioned rotatable coupling.

Preferably, the first coupling pin 120 is made in the form of a screw having a threaded rod terminal portion and a non-threaded cylindrical intermediate portion 121. Such cylindrical intermediate portion 121 is comprised at least within the first receiving seat 211 and allows the hinging body 110 to rotate.

In such case, the rod terminal portion is coupled with corresponding threaded portions made in the second receiving seats 212.

Preferably, such threaded portions of the second receiving seats 212 are made in the front 210 on the side of the second surface 210b in the case where the second receiving seats 212 extend from the first surface 210a of the front 210.

Preferably, the threaded portions second receiving seats 212 are made in the front 210 on the side of the first surface 210a in the case where the second receiving seats 212 extend from the second surface 210b of the front 210.

In a particular embodiment, as shown in figures, the temples 220 comprise two openings 221 facing the interspace between the temples 220 and the front 210. Furthermore, the hinging body 110 also comprises a second through hole 114 arranged at a respective opening 221 and coaxial thereto.

In such case, the hinge assembly 100 also comprises a second coupling pin 140 housed in a respective opening 221 and which passes through the second through hole 114 so as to couple the hinging body 110 to the respective temple 220.

Preferably, the second coupling pin 140 is made in the form of a screw having a threaded rod portion coupled with corresponding threaded portions of the respective opening 221.

In a particular embodiment, as shown in figures, the openings 221 are made within a recess of the respective temple 220 in which it houses the end portion 111 which protrudes overhanging with respect to the respective temple 220.

Preferably, the second through hole 114 and the openings 221 have an axis substantially parallel to the transverse axis Y.

Advantageously, each hinge assembly 100 also comprises an elastic element 130 housed within a respective first receiving seat 211.

The elastic element 130 is interposed between a bottom wall of the respective first receiving seat 211 and the end portion 111 of the hinging body 110. Furthermore, the elastic element 130 is in abutment with such bottom wall and such end portion 111.

In more detail, the elastic element 130 comprises a first end 131 placed in contact and in abutment with the bottom wall of the respective first receiving seat 211 and a second end 132 in contact and in abutment with the end portion 111 of the hinging body 110.

Preferably, the hinge assembly 100 comprises a thrust body 133 interposed between the elastic element 130 and the end portion 111 of the hinging body 110. Furthermore, the thrust body 133 is also in abutment with the elastic element 130 and the end portion 111.

In more detail, the thrust body 133 is in abutment with the second end 132 of the elastic element 130. Preferably, the thrust body 133 is a pressor comprising a blind cavity in which the elastic element 130 is housed.

Advantageously, the elastic element 130 is preloaded in compression with a preloading force.

“Preloaded in compression” means that, in a rest condition in which the respective temple 220 is in the first stable opening position or in the second stable closing position, the elastic element 130 is compressed and exerts a first thrust force that is equal and opposite to the preloading force.

Indeed, the hinging body 110 and the elastic element 130 are configured in such a way that when the respective temple 220 is in the first stable opening position or in the second stable closing position, the elastic element 130 exerts such first thrust force that is equal and opposite to the preloading force on the end portion 111 of the hinging body 110.

Instead, when the respective temple 220 passes from the first stable opening position to the second stable closing position, or vice versa, the elastic element 130 is compressed with a compressive force greater than the preloading force exerted by the end portion 111 of the hinging body 110.

Indeed, when the temple 220 is in an intermediate position between the first stable opening position and the second stable closing position, the elastic element 130 is compressed above the compression given by the preloading force. In such case, such elastic element 130 exerts on the end portion 111 of the hinging body 110 a second thrust force greater than the first thrust force and thus than the preloading force; at this point, if the temple 220 is released by the user, the second thrust force is enough to rotate the hinging body 110 and to return the temple 220 in the first stable opening position or in the second stable closing position.

The hinging body 110 comprises a protrusion 113 made on the end portion 111 which protrudes towards and is in contact with the elastic element 130.

Preferably, the protrusion 113 extends for a length section of the hinging body 110 along a direction substantially parallel to the vertical axis Z.

Such protrusion 113 compresses the elastic element 130 when the respective temple 220 passes from the first stable opening position to the second stable closing position, or vice versa.

In more detail, the more the protrusion 113 approaches an axis of the elastic element 130, the more the compression of the latter increases above that of the preloading; accordingly, even the second thrust force increases above the preloading force and thus above the first thrust force. On the other hand, the more the protrusion 113 moves away from the axis of the elastic element 130, the more the compression of the elastic element 130 decreases, but always remaining greater than that of the preloading; accordingly, even the second thrust force decreases, also remaining always greater than the preloading force and thus than the first thrust force.

Preferably, the maximum compression of the elastic element 130, and thus the maximum second thrust force is made when the protrusion 113 is at a symmetrical axis of the elastic element 130 substantially parallel to the longitudinal axis X.

Furthermore, the first receiving seats 211 comprise a first endstroke wall 211′and a second endstroke wall 211″ opposite to the first endstroke wall 211′.

The protrusion 113 slides between the first endstroke wall 211′and the second endstroke wall 211″ when the respective temple 220 passes from the first stable opening position to the second stable closing position, or vice versa. When the respective temple 220 is in the first stable opening position, the protrusion 113 is in contact and in abutment with the first endstroke wall 211′; when the respective temple 220 is in the second stable closing position, the protrusion 113 is in contact and in abutment with the second endstroke wall 211″.

Furthermore, the above-mentioned first thrust force allows the protrusion 113 to be kept stationary in contact and in abutment with the first endstroke wall 211′when the respective temple 220 is in the first stable opening position or with the second endstroke wall 211″ when the respective temple 220 is in the second stable closing position. In both cases, the thrust force does not allow the hinging body 110 to spontaneously rotate, for example, under the effect of a weight of the respective temple 220.

In more detail, when the respective temple 220 passes from the first stable opening position to the second stable closing position, the protrusion 113 compresses the elastic element 130, slides on the second end 132 from the first endstroke wall 211′to the second endstroke wall 211″; when the respective temple 220 passes from the second stable closing position to the first stable opening position, the protrusion 113 compresses the elastic element 130, slides on the second end 132 from the second endstroke wall 211″ to the first endstroke wall 211′.

Furthermore, during the passage from the first stable opening position to the second stable closing position, or vice versa, if the user releases the respective temple 220 when the protrusion 113 is between the first endstroke wall 211′and the axis of the elastic element 130, the second thrust force exerted on the protrusion 113 forces the hinging body 110 in rotation returning the respective temple 220 in the first stable opening position. In such case, the protrusion 113 slides on the second end 132 of the elastic element 130 until such protrusion 113 returns in contact and in abutment with the first endstroke wall 211′; if the user releases the temple 220 when the protrusion 113 is between the second endstroke wall 211″ and the axis of the elastic element 130, the second thrust force exerted on the protrusion 113 forces the hinging body 110 in rotation returning the respective temple 220 in the second stable closing position. In such case, the protrusion 113 slides on the second end 132 of the elastic element 130 until such protrusion 113 returns in contact and in abutment with the second endstroke wall 211″.

According to an alternative embodiment of the glasses 200, as shown in FIG. 9, the thrust body 133 is made in a different shape with respect to the thrust body 133 illustrated for example in FIG. 8.

In particular, such alternative embodiment differs from that of FIG. 8 in that the thrust body 133 has a cylindrical shape instead of a prismatic shape.

The features of the glasses being the object of the present invention are clear from the performed description, as well as the related advantages are clear.

Indeed, the glasses according to the present invention comprise a few joint elements and ensure, in addition to the stability of the temples in both opening and closing position, also an easier operation of replacing the hinge assembly itself and/or the temples in case of damaging, breaking, or customizing thereof.

It is clear, finally, that the glasses thus conceived are susceptible of a number of modifications and variations, all falling within the invention; furthermore, all the details are replaceable by technically equivalent elements. In practice, the used materials, as well as the size, will be any depending on the technical requirements.

1. Glasses (200) comprising:
a front (210) and two temples (220) rotatably coupled to said front (210) so as to rotate between a first stable opening position and a second stable closing position, said front (210) comprising two first open receiving seats (211) facing said temples (220);
two hinge assemblies (100) by means of which said temples (220) are rotatably coupled to said front (210), each of said hinge assemblies (100) comprising:
a hinging body (110) coupled to a respective temple (220) so that it has an end portion (111) which protrudes overhanging with respect to said temple (220) and penetrates at least a portion of a respective one of said first receiving seats (211) in which it is rotatably coupled to said front (210),
an elastic element (130) being housed within said respective first receiving seat (211), said elastic element (130) being interposed between a bottom wall of said respective first receiving seat (211) and said end portion (111) of said hinging body (110), said elastic element (130) being in abutment with said bottom wall and said end portion (111), said elastic element (130) being preloaded in compression with a preloading force,
said hinging body (110) and said elastic element (130) being configured in such a way that when the respective temple (220) is in the first stable opening position or in the second stable closing position, said elastic element (130) exerts a first thrust force that is equal and opposite to the preloading force on the end portion (111) of said hinging body (110), and when the respective temple (220) passes from the first stable opening position to the second stable closing position, or vice versa, said elastic element (130) is compressed with a compressive force greater than said preloading force exerted by said end portion (111) of said hinging body (110).

2. Glasses (200) according to claim 1 wherein said hinging body (100) comprises:
a protrusion (113) made on said end portion (111) of said hinging body (110) which protrudes towards and is in contact with said elastic element (130), said protrusion (113) compresses said elastic element (130) when the respective temple (220) passes from the first stable opening position to the second stable closing position or vice versa.

3. Glasses (200) according to claim 1 wherein said first receiving seat (211) comprises a first endstroke wall (211′) and a second endstroke wall (211″) opposite to said first endstroke wall (211′), said protrusion (113) being in contact and in abutment with said first endstroke wall (211′) when the respective temple (220) is in the first stable opening position, said protrusion (113) being in contact and in abutment with said second endstroke wall (211″) when the respective temple (220) is in the second stable closing position.

4. Glasses (200) according to claim 1, wherein said hinge assembly (100) comprises a thrust body (133) interposed between said elastic element (130) and said end portion (111) of said hinging body (110), said thrust body (133) also being in abutment with said elastic element (130) and said end portion (111).

5. Glasses (200) according to claim 4 wherein said thrust body (133) is a pressor comprising a blind cavity in which said elastic element (130) is housed.

6. Glasses (200) according to one claim 1, wherein said front (210) comprises two second receiving seats (212) in communication with said first receiving seats (211) and having an axis that is transverse with respect to that of the first receiving seats (211), said end portion (111) being provided with a first through hole (112) arranged at a respective second receiving seat (212) and coaxial thereto, said hinge assembly (100) comprising a first coupling pin (120) which is housed in said respective second receiving seat (212) and which passes through said first through hole (112) so as to achieve a rotatable coupling with said end portion (111).

7. Glasses (200) according to claim 6 wherein the axes of said first receiving seats (211) and said second receiving seats (212) are substantially mutually perpendicular.

8. Glasses (200) according to claim 1 wherein said temples (220) comprise two openings (221) facing the interspace between said temples (220) and said front (210), said hinging body (110) comprising a second through hole (114) arranged at a respective opening (221) and coaxial thereto, said hinge assembly (100) comprising a second coupling pin (140) which is housed in a respective opening (221) and which passes through said second through hole (114) so as to couple said hinging body (110) to the respective temple (220).
